(19) United States
(12) Patent Application Publication
(10) Pub. No.: US 2009/0271360 A1
(43) Pub. Date: Oct. 29, 2009

(54) Assigning Plan Volatility Scores to Control Reoptimization Frequency and Number of Stored Reoptimization Plans

(76) Inventors: Robert J. Bestgen, Rochester, MN (US); Shantan Kethireddy, Chicago, IL (US)

Correspondence Address: Craig F. Taylor, 774 Randy Avenue, Shoreview, MN, 55126-2905, US

(21) Appl. No.: 12/109,592

(22) Filed: Apr. 25, 2008

(51) Int. Cl. G06F 17/30

(52) U.S. Cl. 707/2; 707/E17.017

(57) ABSTRACT

Methods, systems, and computer program products are provided for improving the processing of database queries. Some embodiments include generating volatility scores for various plans for executing similar database queries. Different embodiments may utilize: database statistics, the variable values being selected for, and/or historical run time data, to generate the plan volatility scores. In some embodiments, the volatility scores are used to determine whether to generate a new plan for a query, whether to prune an existing plan, and/or how many different plans to store for a query.

### BACKGROUND

1. Technical Field

The field of the invention is data processing, or, more specifically, methods, apparatus, and products for monitoring and managing database queries for improving performance.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Information stored on a computer system is often organized in a structure called a database. A database is a grouping of related structures called ‘tables,’ which in turn are organized in rows of individual data elements. The rows are often referred to as ‘records,’ and the individual data elements are referred to as ‘fields.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:
select * from stores, transactions
where stores.location=“Minnesota”
and stores.storeID=transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’

In many systems, the SQL queries are parsed, a logical plan created, and at least one, often multiple physical plans created for executing the logical plan to execute the SQL query. The multiple physical plans arrive at the same correct output, but can take greatly varying times to arrive at that output, depending on which plan is selected for execution. The best plan to execute is usually the plan having the lowest/cheapest expected cost, typically selected by the query optimizer.

In database query processing, the algorithms used by the query optimizer to implement the query are based on the ‘best’ plan that the optimizer selects using statistics over the underlying tables and columns. This is called the cost based model and is the defacto standard for databases.

One problem with this mechanism is that the chosen plan is selected based on the lowest expected cost. However, in practice, this selection process sometimes chooses a very inferior plan primarily because the available statistics fail to match reality during this execution. The resulting long running queries can be a major source of user frustration, troubleshooting, and support costs.

The problems of long running queries can be addressed by optimizing query plans and the problem of long running query optimizations can be addressed by storing optimized plans in a cache for re-use in the appropriate situations, should they arise again. Previously optimized plans can be re-optimized in an attempt to obtain better query processing times. However, this should not be done indiscriminately as this also uses resources. In addition, all previously optimized plans cannot be stored indiscriminately and forever, as this also requires the use of too many resources.

Improved methods for deciding how often to force re-optimization of a query and how many different plans to store for a query would be advantageous.

### SUMMARY

Methods, systems, and computer program products are provided for managing a database (DB) query system having a DB query plan repository, where the DB query plan repository can store more than one DB query plan for each DB query. One such method includes steps which, for each DB query plan for a DB query, determine a volatility score for the DB query plan, and for each DB query, determine a number of DB query plans to store for the DB query at least in part as a function of the DB query plan volatility score. In some embodiments, the DB query plan volatility score is determined at least in part as a function of a value contained in the DB query. The DB query plan volatility score may be determined at least in part as a function of a DB table statistic in some methods. The DB table statistic can be selected from at least one of the group of skew, cardinality, selectivity, clusteredness, and combinations thereof, depending on the embodiment.

In some embodiments, the DB query plan volatility score is determined at least in part as a function of actual run time data for the DB query plan. The actual run time data can be selected from at least one of minimum run time, maximum run time, and average run time. Some DB queries involve at least one index, in which the plan volatility score is determined at least in part as a function of the number of indices involved in the query. A DB query may involve at least one table, in which the plan volatility score is determined at least in part as a function of the number of tables involved in the query.

Some methods according to the present invention include displaying the plan volatility scores, and may include accepting user input to set a plan volatility score. In some methods, plan re-optimization is determined at least in part as a function of the plan volatility score and a threshold, where the threshold can be manipulated by the user. The number of plans stored can be determined at least in part by user input in some embodiments.

Some embodiments of the present invention assign a volatility score to each of the DB query plans. The volatility score can provide a numerical indication of how changes in the Host Variable Values (HVVs) affect the optimized plan. The volatility score can be used to determine how many individual plans should be stored for a given query in the plan cache. The volatility score can be used in conjunction with other plan scores to determine whether a plan should stay in a pseudo open mode or whether the plan should be re-optimized more frequently. In a pseudo-open mode the plan is essentially ready to run, and may have a cursor serving as an entry point into the query.

One practical application of the volatility score may be seen when working with commonly run customer queries over very large database (VLDB) queries. In one example, a very large join network with many tables having skewed data and correlated data is involved in the query. The best or “good enough” plan can be highly dependent upon the host variable values. Therefore, the volatility score along with another plan score can be used to urge more numerous optimized plans to be saved for the query.

In some embodiments, the SQL Query engine maintains a volatility score for every plan in the plan cache. The volatility score is externalized in some embodiments. Externalizing the score can allow users to force the optimizer to store more optimized plans for a given query. This can also be used to signal the optimizer to perform optimizations more often and/or to perform deeper optimizations, depending on the embodiment.

In one example of the invention, for each query, the optimizer determines the volatility of the underlying databases and the columns referenced. The volatility may be at least in part a function of factors such as data skew, correlation effect (e.g. month and month-name referenced in the same query), as well as how often the plan has been seen with differing host variable values. The volatility score may also take into account the maximum, minimum, and average execution time and/or the maximum, minimum, and average optimization time.

In some embodiments, when a query is in pseudo open mode, the optimizer can determine whether the host variable values have changed in such a way that would warrant a re-optimization or using a secondary plan stored in the plan repository. This determination can be based at least in part on the plan volatility score and/or database statistics, depending on the embodiment. When a query is not in pseudo open mode and is attempting to be matched to an existing plan, the optimizer may use the volatility score along with another plan score and the host variable values (and sub-combinations thereof) to determine whether another version of the optimized plan should be maintained.

Some embodiments of the present invention also include a system for processing database queries, the system including a computer processor and a computer memory operatively coupled to the computer processor. The computer memory can have disposed within it computer program instructions capable of executing the various methods described in the present application. Also provided is a computer program product for processing database queries, the computer program product disposed in a computer readable signal bearing medium. The computer program product includes computer program instructions capable of executing the various methods described in the present application.

The foregoing and other features and aspects of the invention will be apparent from the following more particular descriptions of exemplary embodiments of the invention as illustrated in the accompanying drawings, wherein like reference numbers generally represent like parts of exemplary embodiments of the invention.

### BRIEF DESCRIPTION OF THE DRAWINGS

FIG. 1 is a network diagram of a system for processing database queries according to embodiments of the present invention.

FIG. 2 is a block diagram of an exemplary system for processing database queries in accordance with the present invention according to embodiments of the present invention.

FIG. 3 is a block diagram of automated computing machinery comprising a computer useful in processing database queries in accordance with the present invention.

FIG. 4 is a high level flow chart of a method for processing database queries.

FIG. 5 is a more detailed view of the method of FIG. 4, showing the results of SQL handling when multiple plans may be generated but not necessarily including plan storage.

FIG. 6 is a high level flow chart of a method according to some embodiments of the invention.

### DETAILED DESCRIPTION OF EXEMPLARY EMBODIMENTS

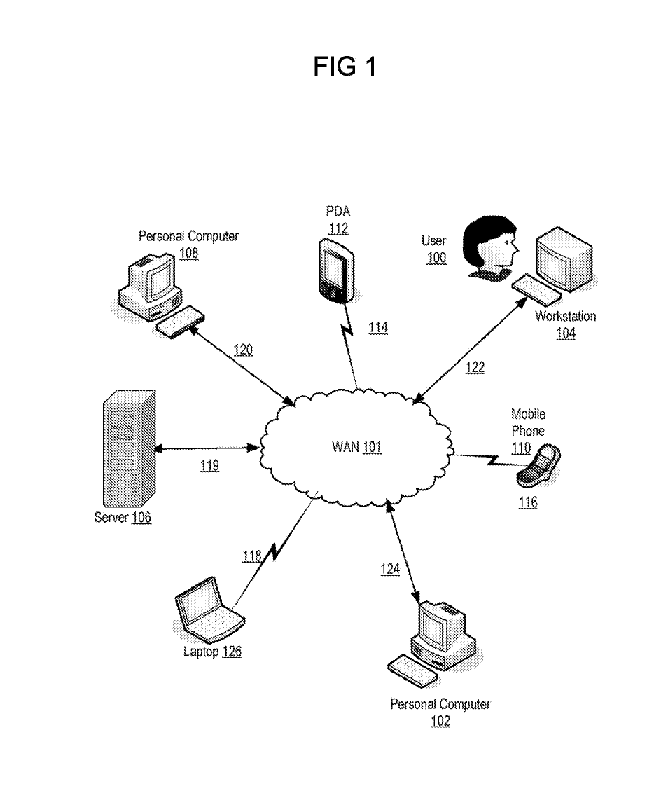

FIG. 1 depicts an exemplary data processing system capable of processing database queries for query processing according to embodiments of the present invention. The system of FIG. 1 includes a number of computers connected for data communications in networks. Each of the computers of the system of FIG. 1 may have installed upon it a database management system capable of processing database queries in accordance with the present invention. The data processing system of FIG. 1 includes wide area network (“WAN”) 101. The network connection aspect of the architecture of FIG. 1 is only for explanation, not for limitation. In fact, systems for processing database queries according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, several exemplary devices including a PDA 112, a computer workstation 104, a mobile phone 110, personal computer 102, a laptop 126, a server 106, and another personal computer 108 are connected to WAN 101. The network-enabled mobile phone 110 connects to WAN 101 through wireless link 116, the PDA 112 connects to network 101 through wireless link 114 and the laptop 126 connects to the network 101 through a wireless link 118. In the example of FIG. 1, the personal computer 108 connects through a wireline connection 120 to WAN 101, the computer workstation 104 connects through a wireline connection 122 to WAN 101, the personal computer 108 connects through a wireline connection 124 to WAN 101, and the server 106 connects through a wireline connection 119 to WAN 101. In the system of FIG. 1, exemplary devices 120, 108, 112, 104, 106, 110, 126, and 102 support a database management system capable of processing database queries and interacting with a user 100.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1

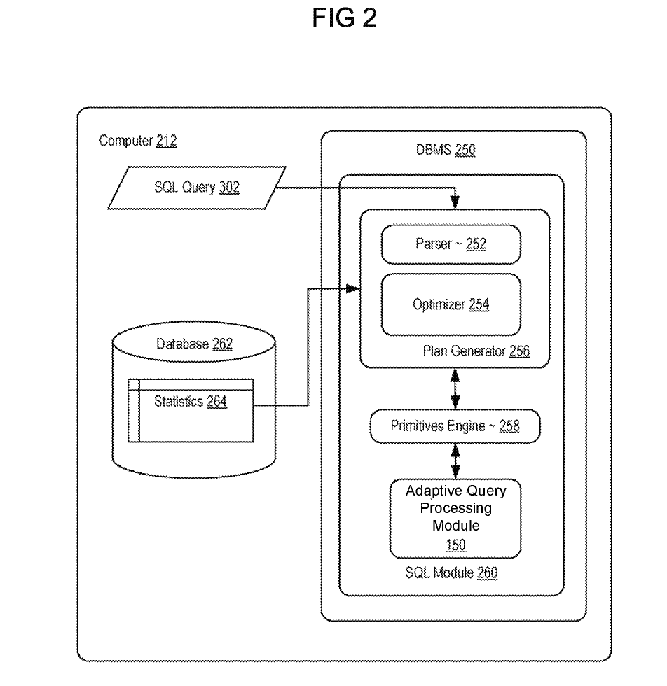

FIG. 2 is a block diagram of an exemplary system for processing database queries in accordance with the present invention according to embodiments of the present invention. The system of FIG. 2 includes a computer 212 having installed upon it a database management system (‘DBMS’) 250. DBMS 250 administers access to the contents of the database 262. The DBMS 250 includes an SQL module 260. The SQL module is implemented as computer program instructions that execute a SQL query 302.

The exemplary SQL module 260 of FIG. 2 also includes an exemplary plan generator 256. Each SQL query is carried out by a sequence of database operations specified as a plan. The plan generator of FIG. 2 is implemented as computer program instructions that create a plan for a SQL query. A plan is a description of database functions for execution of an SQL query. Taking the following SQL query as an example:
select * from stores, transactions
where stores.storeID=transactions.storeID,
   plan generator 256 may generate the following exemplary plan for this SQL query:
tablescan stores
join to
index access of transactions

This plan represents database functions to scan through the stores table and, for each stores record, join all transactions records for the store. The transactions for a store are identified through the storeID field acting as a foreign key. The fact that a selection of transactions records is carried out for each store record in the stores table identifies the join function as iterative.

The exemplary plan generator 256 of FIG. 2 includes a parser 252 for parsing the SQL query. Parser 252 is implemented as computer program instructions that parse the SQL query. A SQL query is presented to SQL module 260 in text form, the parameters of an SQL command. Parser 252 retrieves the elements of the SQL query from the text form of the query and places them in a data structure more useful for data processing of an SQL query by an SQL module.

The exemplary plan generator 256 also includes an optimizer 254 implemented as computer program instructions that optimize the plan in dependence upon database management statistics 264. Optimizer 254 optimizes the execution of SQL queries against DBMS 250. Optimizer 254 is implemented as computer program instructions that optimize execution of a SQL query in dependence upon database management statistics 264. Database statistics are typically implemented as metadata of a table, such as, for example, metadata of tables of database 262 or metadata of database indexes. Database statistics may include, for example:
histogram statistics: a histogram range and a count of values in the range,
frequency statistics: a frequency of occurrence of a value in a column, and
cardinality statistics: a count of the number of different values in a column.

These three database statistics are presented for explanation only, not for limitation. Such database statistics can be used together with the values in a particular query to decide which physical plan to use and whether a new plan should be generated.

The exemplary SQL module 260 of FIG. 2 also includes a primitives engine 258 implemented as computer program instructions that execute primitive query functions in dependence upon the plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of a plan and are identified in the plan. Examples of primitives include the following database instructions:
retrieve the next three records from the stores table into hash table H1
retrieve one record from the transactions table into hash table H2
join the results of the previous two operations
store the result of the join in table T1

The SQL module 260 of FIG. 2 also includes an adaptive query processing module 150. The adaptive query processing module 150 of FIG. 2 is capable of processing database queries according to the present invention. The adaptive query processing module 150 includes computer program instructions capable of identifying poorly performing queries; substituting an alternate plan to execute the query; and executing the query using the alternate plan.

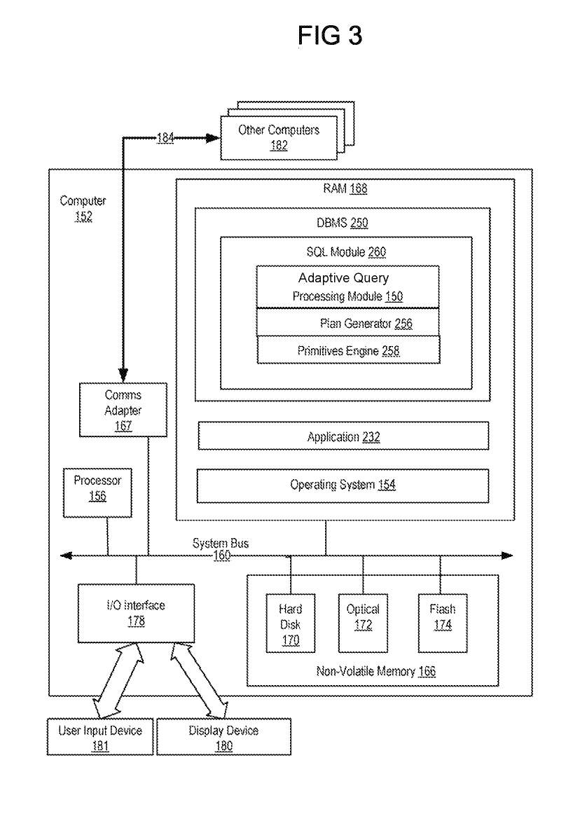

FIG. 3 is a block diagram of automated computing machinery comprising a computer 152 useful in processing database queries in accordance with the present invention according to embodiments of the present invention. The computer 152 of FIG. 3 includes at least one computer processor 156 or ‘CPU’ as well as random access memory 168 (“RAM”). Stored in RAM 168 is database management system 250. The database management system 250 of FIG. 3 includes an SQL module 260, which in turn includes a plan generator 256 and a primitives engine 258.

The SQL module 260 of FIG. 3 also includes an adaptive query processing module 150. The adaptive query processing module 150 was described with respect to FIG. 2. Also stored in RAM 168 is an application 232, a computer program that uses the DBMS 250 to access data stored in a database. Also stored in RAM 168 is an operating system 154. Operating systems useful in computers according to embodiments of the present invention include Unix, Linux, Microsoft NT_{TM}, i5OS, and many others as will occur to those of skill in the art. Operating system 154, DBMS 250, and application 154 in the example of FIG. 3 are shown in RAM 168, but many components of such software typically are stored in non-volatile memory 166 also.

The computer 152 of FIG. 3 includes non-volatile computer memory 166 coupled through a system bus 160 to processor 156 and to other components of the computer. Non-volatile computer memory 166 may be implemented as a hard disk drive 170, optical disk drive 172, electrically erasable programmable read-only memory space (so-called ‘EEPROM’ or ‘Flash’ memory) 174, RAM drives (not shown), or as any other kind of computer memory as will occur to those of skill in the art.

The exemplary computer 152 of FIG. 3 includes a communications adapter 167 for implementing connections for data communications 184, including connections through networks, to other computers 182, including servers, clients, and others as will occur to those of skill in the art. Communications adapters implement the hardware level of connections for data communications through which local devices and remote devices or servers send data communications directly to one another and through networks. Examples of communications adapters useful according to embodiments of the present invention include modems for wired dial-up connections, Ethernet (IEEE 802.3) adapters for wired LAN connections, and 802.11b adapters for wireless LAN connections.

The example computer of FIG. 3 includes one or more input/output interface adapters 178. Input/output interface adapters in computers implement user-oriented input/output through, for example, software drivers and computer hardware for controlling output to display devices 180 such as computer display screens, as well as user input from user input devices 181 such as keyboards and mice.

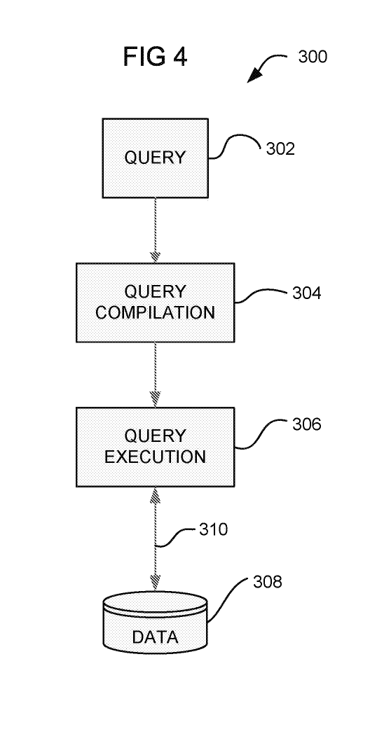

FIG. 4 illustrates a method 300 for processing an SQL query. A query 302, for example an SQL query, is received. The query can be compiled as indicated 304, and executed at 306. Query execution 306 can both write data to data store 308 and read data from data store 308, as indicated at 310.

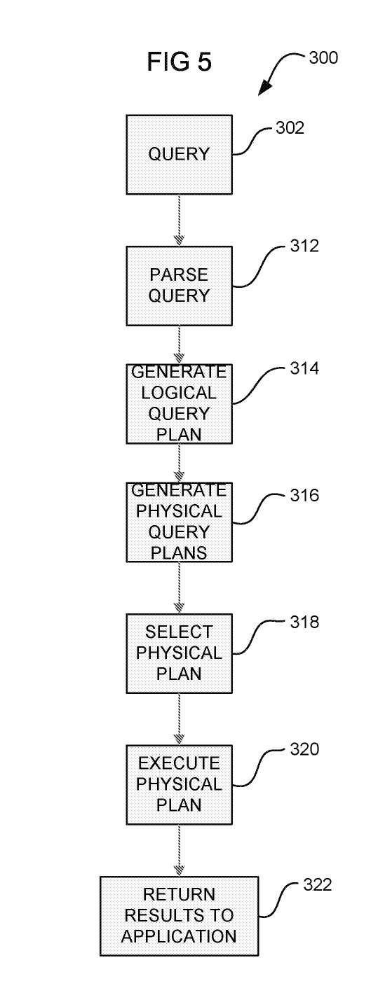

FIG. 5 is a more detailed view of method 300 of FIG. 4. Method 300 can include query 302 being parsed in parse query step 312 and a logical query plan generated in step 314. The results of the logical query plan can be used to generate multiple, logically equivalent physical query plans in step 316. One of the logical query plans, likely the lowest cost plan, can be selected for execution in step 318. The selected physical plan can be executed in step 320 and the results of the query returned to the application in step 322.

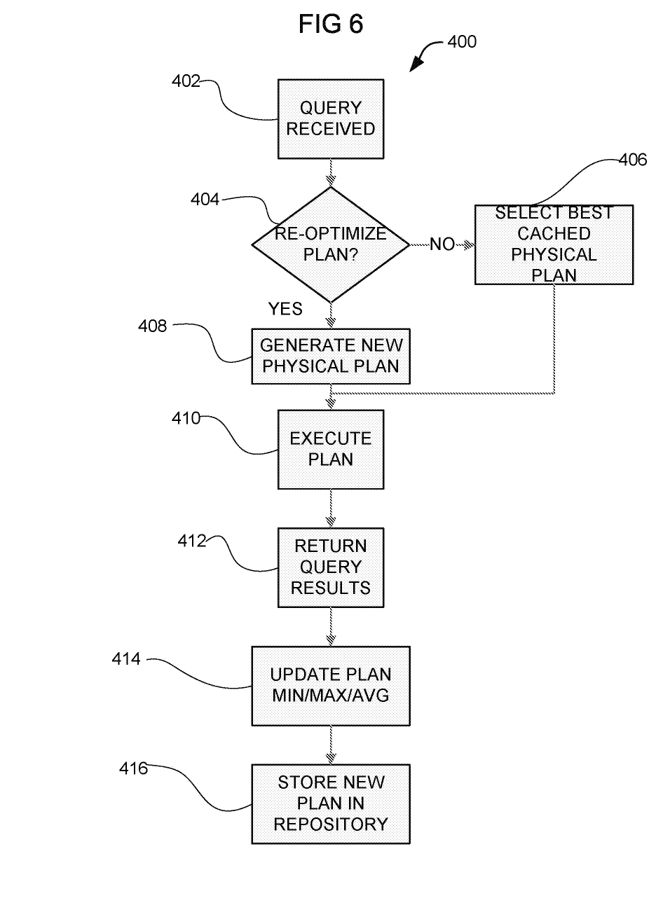

FIG. 6 illustrates a method 400 including one embodiment of the invention. Method 400 receives a database query at 402 and parses and processes the query in part, as previously described. In step 404 a decision is made as to whether or not to generate another plan for this query. This decision is part of some embodiments of the present invention, as described further below. Existing plans in the repository (if any) can have volatility scores associated with the plans. The volatility scores can be generated both as a function of the stored plan attributes and as a function of the variables contained in the query, also referred to as the host variable values (HVVs). The HVVs can be numbers, literals, or strings being searched for.

If no new plan is generated in light of the past run time history, the database statistics, or the HVV, then the risk is taken that the plan executed may take much longer to run than expected, for example, 5 minutes instead of 5 seconds. If a new plan is generated every time a query is received, then the cached plans are of little use and the time required to generate the new plans will itself slow down the query processing. Some embodiments provide ways to improve decision making as to whether or not a new plan should be generated.

Volatility scores can be stored which reflect the minimum, maximum, and average run times of previous executions of each plan in the plan cache. When a plan is found in the cache that is otherwise suitable for the query, the past run time data can provide a gauge of the volatility of the plan. For example, a min, max, and average run time which are close in range to each other would indicate a low degree of volatility or low volatility score, as would a max and average run time close to each other.

The database statistics can also be used to generate a volatility score. If the query operates on a certain column, then statistics for that column can be used to generate a volatility score the plan for the HVV being selected for in that column. In one example, if the HVV is found infrequently in the column, then a plan using an index may be beneficial. If the HVV is found frequently in the column, then a full table scan may be beneficial. In another example, if the table column is highly skewed, then the query plan execution is likely to be more volatile, and a plan utilizing an index may be called for. In some embodiments, the clusteredness may be used to affect the volatility score. Clustered data may be clustered together rather than evenly or randomly distributed. Clustered data may suggest a plan using an index and may increase volatility as the execution time may be more dependent on the HVV.

In some embodiments, the plan volatility is compared to a threshold acceptable volatility and a plan generated if the existing plan is more volatility than the threshold. In one example, different thresholds are associated with different query types, with some query types having a low threshold, and a low toleration for plan volatility. Some embodiments allow display of plan volatility to users and also allow user manipulation of plan volatility scores and/or acceptable volatility thresholds.

Some embodiments of the invention provide different plans for queries which differ only in one or more HVVs. Highly volatile plans may be highly variable in run time as a function of the HVV, which may call for different plans for different HVVs.

Step 404 can also be used to validate the existing plans, for example, to make sure that any indices relied on for the plan still exist. If the existing plan is invalid, then a new plan may be generated.

If an existing plan is acceptable, it can be selected in step 406. If not, a new plan can be generated in step 408. In step 410, the plan can be executed, with the query results returned to the user in step 412.

In step 414, the run time of this execution of the plan can be used to update the historical data for the executed plan, for example the minimum, maximum, and average run time. This data can also be used to update the volatility score for this plan.

In step 416, the plan can be stored in the plan repository if new, or the existing plan historical and volatility attributes updated. In some embodiments, the decision as to whether to store a new plan or even prune an existing plan can be made in step 416. Some embodiments have a limit on the number of plans to store for a query and a limit may be reached at this point, with the newest plan either not stored or an older plan purged to make room. The plan volatility scores can be used to determine how many plans to store, with high volatility scores suggesting a larger number of otherwise similar plans being stored for the same query. In some embodiments the size of the plan repository can be determined on the fly, in a step similar to step. In other embodiments, such decisions can be made asynchronously, by jobs running in the background.

Exemplary embodiments of the present invention are described largely in the context of a fully functional computer system for processing database queries. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for managing a database (DB) query system having a DB query plan repository, where the DB query plan repository can store more than one DB query plan for each DB query, the method comprising:
for each DB query plan for a DB query, determine a volatility score for the DB query plan; and
for each DB query, determine a number of DB query plans to store for the DB query at least in part as a function of the DB query plan volatility score.

2. The method of claim 1, in which the DB query plan volatility score is determined at least in part as a function of a value contained in the DB query.

3. The method of claim 2, in which the DB query plan volatility score is determined at least in part as a function of a DB table statistic.

4. The method of claim 3, in which the DB table statistic is selected from at least one of the group of DB table statistics consisting of skew, cardinality, selectivity, clusteredness, and combinations thereof.

5. The method of claim 2, in which the DB query plan volatility score is determined at least in part as a function of actual run time data for the DB query plan.

6. The method of claim 5, in which the actual run time data is selected from at least one of the group consisting of minimum run time, maximum run time, and average run time.

7. The method of claim 2, in which the DB query involves at least one index, in which the plan volatility score is determined at least in part as a function of the number of indices involved in the query.

8. The method of claim 2, in which the DB query involves at least one table, in which the plan volatility score is determined at least in part as a function of the number of tables involved in the query.

9. The method of claim 1, further comprising displaying the plan volatility scores.

10. The method of claim 1, further comprising re-optimizing or generating a new DB query plan at least in part as a function of the volatility score.

11. The method of claim 10, further comprising accepting user input to set a plan volatility score.

12. The method of claim 10 in which the re-optimization is determined at least in part as a function of the plan volatility score and a threshold in which the threshold can be manipulated by the user.

13. The method of claim 1 in which the number of plans stored is determined at least in part by user input.

14. A system for managing database (DB) queries, the DB system having a DB query plan repository, where the DB query plan repository can store more than one DB query plan for each DB query, the system comprising a computer processor, a computer memory operatively coupled to the computer processor, the computer memory having disposed within it computer program instructions capable of executing a method comprising:
for each DB query plan for a DB query, determine a volatility score for the DB query plan; and
for each DB query, determine a number of DB query plans to store for the DB query at least in part as a function of the DB query plan volatility score.

15. The system of claim 14 wherein the computer program instructions further comprise computer program instructions capable of:
determining the DB query plan volatility score at least in part as a function of a value contained in the DB query.

16. The system of claim 14 wherein the computer program instructions further comprise computer program instructions capable of:
determining the DB query plan volatility score at least in part as a function of a DB table statistic, in which the DB table statistic is selected from at least one of the group of DB table statistics consisting of skew, cardinality, selectivity, clusteredness, and combinations thereof.

17. A computer program product for managing a database (DB) query system having a DB query plan repository, where the DB query plan repository can store more than one DB query plan for each DB query, the computer program product disposed in a computer readable signal bearing medium, the computer program product comprising computer program instructions capable of executing a method comprising:
for each DB query plan for a DB query, determine a volatility score for the DB query plan; and
for each DB query, determine a number of DB query plans to store for the DB query at least in part as a function of the DB query plan volatility score.

18. The computer program product of claim 17 wherein the computer program instructions further comprise computer program instructions capable of:
determining the DB query plan volatility score at least in part as a function of a value contained in the DB query.

19. The computer program product of claim 17 wherein the computer program instructions further comprise computer program instructions capable of:
re-optimizing or generating a new DB query plan at least in part as a function of the volatility score.

20. The computer program product of claim 17 wherein the computer program instructions further comprise computer program instructions capable of:
determining the DB query plan volatility score at least in part as a function of actual run time data for the DB query plan, and in which the actual run time data is selected from at least one of the group consisting of minimum run time, maximum run time, and average run time.
